(19) United States
(12) Patent Application Publication
(10) Pub. No.: US 2008/0144219 A1
(43) Pub. Date: Jun. 19, 2008

(54) CONDUCTIVE PFPE DISK LUBRICANT

(76) Inventors: John M. Burns, San Jose, CA (US); Malika D. Carter, San Jose, CA (US); Cynthia Delenia, Morgan Hill, CA (US)

Correspondence Address: PATTERSON & SHERIDAN, L.L.P., 3040 POST OAK BLVD., SUITE 1500, HOUSTON, TX, 77056, US

(21) Appl. No.: 11/612,590

(22) Filed: Dec. 19, 2006

(51) Int. Cl. G11B 5/82; C10M 159/12

(52) U.S. Cl. 360/135; 508/548

(57) ABSTRACT

Embodiments of the invention generally relate to PFPE lubricants, and more specifically to increasing the conductivity of PFPE lubricants. PFPE lubricants generally have low polarity and do not dissolve most conductive additives that tend to be highly polar. However, hydrophobic ionic liquids are highly fluorinated and have low polarity. Therefore, the hydrophobic ionic liquids may be dissolved in a PFPE lubricant to increase the conductivity of the PFPE lubricant.

### BACKGROUND OF THE INVENTION

1. Field of the Invention

Embodiments of the present invention generally relate to perfluoropolyether (PFPE) lubricants, and more specifically to increasing the conductivity of PFPE lubricants.

2. Description of the Related Art

Nearly every kind of computer today, be it a desktop computer, server, mainframe or supercomputer contains at least one hard disk drive (HDD). In fact, many modern electronic devices, such as camcorders and VCRs incorporate hard disk drives. The advantage of including hard disk drives is that they can store large amounts of information including the programs and data required to operate and use computers and electronic devices.

A hard disk drive comprises several mechanical components such as magnetic disks, motors, actuator arms and electromagnetic heads to read and write data. A magnetic disk may contain concentric data tracks containing the data stored on the disks. The actuator arm may be coupled with an electromagnetic head. The electromagnetic head may be placed on a track of an associated disk to perform read and write operations. Motors may rotate the magnetic disks or move the actuator arms to place a head at a particular location on a disk to facilitate reading and writing data to the magnetic disk.

Lubricants may be applied to various components in a hard disk drive to reduce friction between moving parts, thereby reducing wear and tear of the parts. For example, lubricants may be used on the surface of magnetic disks to reduce friction at the head/disk interface and in components of a fluid dynamic bearings (FDB) motor. In some cases, it may be desirable to apply conductive lubricants to HDD components. For example, lubricants used in a FDB motor are generally required to be conductive to allow dissipation of undesired charge build-up on magnetic disks.

Perfluoropolyether (PFPE) lubricants are commonly used on several HDD components. PFPEs are a family of fluorinated synthetic fluids that are used to formulate lubricants that function for long periods of time in extreme environments. PFPE's are long chain fluoropolymers that are slippery and wet surfaces well, thereby making excellent lubricants. Moreover, PFPE's such as Ausimont Fomblin Z-DOL, Z-Tetraol, AM2001 and AM3001 are widely used for several disk drive applications such as magnetic disk lubrication.

However, one problem with PFPE lubricants is that it has poor conductivity. Furthermore, low polarity of the fluorinated PFPE lubricants leads to poor solubility and/or affinity with most additives. Therefore, tailoring the conductivity of PFPE lubricants has proven to be problematic because conductive additives, which are typically polar species, are immiscible with PFPE lubricants.

Accordingly, there is a need for methods to tailor the conductivity of PFPE lubricants.

### SUMMARY OF THE INVENTION

The present invention generally relates to perfluoropolyether (PFPE) lubricants, and more specifically to increasing the conductivity of PFPE lubricants.

One embodiment of the invention provides a method for increasing the conductivity of a perfluoropolyether (PFPE) lubricant. The method generally comprises dissolving a predetermined amount of the PFPE lubricant in a solvent, dissolving a predetermined amount of a hydrophobic ionic liquid in the solvent, and evaporating at least some of the solvent, thereby leaving a mixture of the PFPE lubricant and the hydrophobic ionic liquid, wherein the hydrophobic ionic liquid increases the conductivity of the PFPE lubricant.

Another embodiment of the invention provides a hard disk drive generally comprising one or more magnetic disks and a FDB motor configured to rotate the one or more magnetic disks, wherein the FDB motor is lubricated with a conductive PFPE lubricant, the conductive PFPE lubricant comprising a mixture of a PFPE lubricant and a hydrophobic ionic liquid.

Yet another embodiment of the invention provides a lubricant generally comprising a PFPE lubricant and a hydrophobic ionic liquid dissolved in the PFPE lubricant, wherein the hydrophobic ionic liquid is selected to increase the conductivity of the lubricant.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary hard disk drive according to an embodiment of the invention.

FIG. 2 illustrates stacked magnetic disks and electromagnetic heads according to an embodiment of the invention.

FIG. 3 illustrates an exemplary Fluid Dynamics Bearing (FDB) motor according to an embodiment of the invention.

FIG. 4 is a flow diagram of exemplary operations performed to dissolve a hydrophobic ionic liquid in a PFPE lubricant, according to an embodiment of the invention.

FIG. 5A is a table illustrating the results of an experiment demonstrating increase in conductivity of PFPE lubricants.

FIG. 5B is a bar graph illustrating the results of an experiment demonstrating increase in conductivity of PFPE lubricants.

### DETAILED DESCRIPTION

Embodiments of the invention generally relate to PFPE lubricants, and more specifically to increasing the conductivity of PFPE lubricants. PFPE lubricants generally have low polarity and do not dissolve most conductive additives that tend to be highly polar. However, hydrophobic ionic liquids are highly fluorinated and have low polarity. Therefore, the hydrophobic ionic liquids may be dissolved in a PFPE lubricant to increase the conductivity of the PFPE lubricant.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### Exemplary Hard Disk Drive

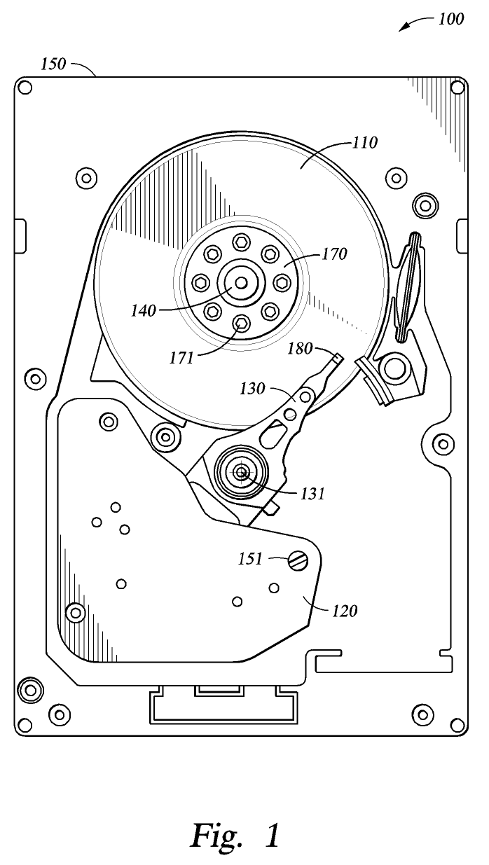

FIG. 1 illustrates a top view of an exemplary hard disk drive (HDD) 100, according to an embodiment of the invention. As illustrated, HDD 100 may include one or more magnetic disks 110, actuator 120, actuator arms 130 associated with each of the magnetic disks, and spindle motor 140 affixed in a chassis 150. The one or more magnetic disks 110 may be arranged vertically as illustrated in FIG. 1. Moreover, the one or more magnetic disks may be coupled with a spindle motor 140.

A top clamp 170 may be placed at the tip end of the spindle motor, as illustrated in FIG. 1. Top clamp 170 may be configured to secure the one or more magnetic disks in place so as to reduce undesired movement of the disks. A plurality of top clamp screws 171 may be employed to tightly couple the magnetic disks and spindle motor using the top clamp.

Magnetic disks 110 may contain circular tracks of data on both the top and bottom surfaces of the disk. An electromagnetic head, for example head 180, may be positioned on a track. As each disk spins, data may be written and read from the data track. Electromagnetic head 180 may be coupled to an actuator arm 130 as illustrated in FIG. 1. Actuator arm 130 may be configured to swivel around actuator axis 131 to place electromagnetic head 180 on a particular data track.

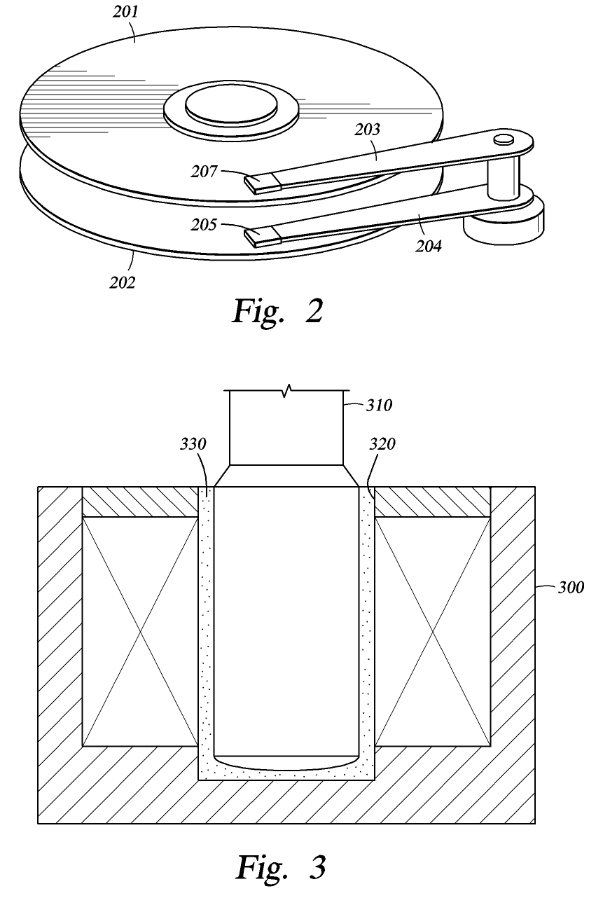

As described above, a plurality of magnetic disks may be stacked vertically in HDD 100. Each disk may have read and write tracks on each side of the disk. Therefore, electromagnetic heads may be placed on both sides of the disk. FIG. 2 illustrates two magnetic disks 201 and 202 that are stacked vertically. Actuator arms 203 and 204 may access data tracks on disks 201 and 202. As illustrated, actuator arm 203 may be coupled with electromagnetic head 207 to access data tracks on the top face of disk 201.

Actuator arm 204 may contain head 205. Head 205 may be configured to access data tracks on the bottom face of disk 201 and on the top face of disk 202. While two magnetic disks are illustrated in FIG. 2, one skilled in the art will recognize that any number of magnetic disks may be vertically stacked with interleaving actuator arms providing heads to access the top and bottom faces of the disks.

Referring back to FIG. 1, each actuator arm 130 may be coupled to actuator 120. Actuator 120 may be a motor configured to control the swiveling movement of actuator arm 130 to place electromagnetic head 180 on a given data track. In one embodiment, the actuator arms may be connected. Therefore, all the actuator arms 130, and consequently all the electromagnetic heads 180 may move together.

Spindle motor 140 may be configured to rotate the magnetic disks at a predetermined rate. For example, the spindle motor 140 may be configured to spin at a rate of 10,000 revolutions per minute (rpm). One skilled in the art will recognize however, that any reasonable spin rate may be employed. The spin rate for example may depend on the type of disk drive, the type of computer, etc.

Spindle motor 140 may include a rod like axle (spindle) inside the hard drive. The magnetic disks 110 may be center-mounted on the spindle, and the spindle motor may rotate the spindle and the magnetic disks 110. In one embodiment of the invention, spindle motor 140 may be a fluid dynamic bearing (FDB) motor. In other words, spindle motor 140 may use fluid as a bearing to rotate the spindle inside a sleeve of the spindle motor.

FIG. 3 illustrates an exemplary spindle motor 300 according to an embodiment of the invention. As illustrated in FIG. 3, spindle motor 140 may include a spindle 310 configured to axially rotate inside a sleeve 320 of spindle motor 300. A spacing 330 may exist between the sides of the spindle 310 and the walls of shaft 320. In one embodiment of the invention, the spacing may be to the order of a few microns in thickness. A fluid lubricant may be placed in the spacing 330 to act as a bearing that facilitates spinning of spindle 310 in the sleeve 320.

In one embodiment of the invention, lubricants placed in the spacing 330 may be conductive. Therefore, the lubricant may facilitate discharges of undesired charge build up on the magnetic disks 110. In other words, undesired charge build up on magnetic disks 110 connected to spindle 310 may dissipate into the body of spindle motor 300 through the conductive lubricant placed in the spacing 330.

In one embodiment of the invention, the lubricant used in spacing 330 may be a PFPE based lubricant. In one embodiment of the invention, the PFPE lubricants may belong to the perfluoropolyoxyalkane family, for example, Z-Dol and Z-Dol-4000 such as that available from Solvay Solexis, Inc. Alternatively, Z-Tetraol such as that available from Solvay Solexis, Inc, or a Cyclotriphosphazene-Terminated Perfluoropolyether lubricant such as A20H available from Matsumura Oil Research Corporation may be used. In one embodiment, one or more of the PFPE lubricants may be mixed, for example, ZDol/A20H.

PFPE lubricants may provide several advantages over other lubricants, for example, higher thermal and chemical stability than conventional lubricants. However, because PFPE lubricants have poor conductivity, the PFPE lubricants must be altered to make them more conductive. The following section describes methods for tailoring the conductivity of PFPE lubricants.

### Conductive PFPE Lubricants

In one embodiment of the invention, increasing conductivity of PFPE lubricants may involve dissolving a predetermined amount of ionic liquid in the PFPE lubricant. Ionic liquids are materials that may be composed substantially of anions and cations. An anion is a negatively charged particle and a cation is a positively charged particle. Ionic liquids may provide several advantages such as thermal stability, electric conductivity, non-flammability, and the like.

In one embodiment of the invention, a small amount of a “hydrophobic ionic liquid” such as that available from Covalent Associates, Inc. may be dissolved into a PFPE lubricant to increase conductivity of the PFPE lubricant. Hydrophobic ionic liquids have a wide liquidus range and offer advantages of low volatility, high thermochemical and electrochemical stability, and low sensitivity to oxidation. Furthermore, hydrophobic ionic liquids are highly fluorinated and therefore have significant solubility in the non-polar PFPE disk lubricants. Exemplary hydrophobic ionic liquids include, for example, 1-Ethyl-3-methylimidazolium bis(pentafluoroethylsulfonyl)-imide (hereinafter referred to as EMIBeti) available from Covalent Associates, Inc.

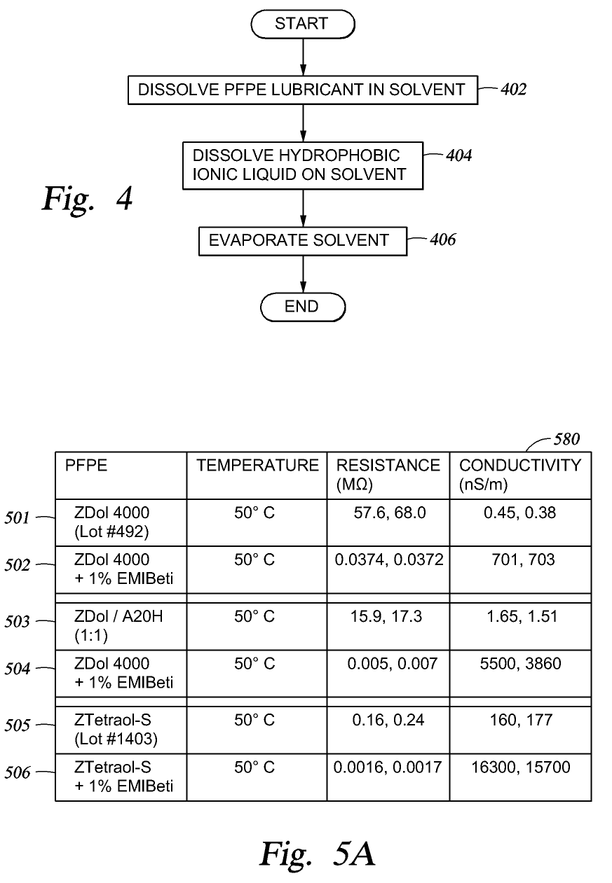

Dissolving a hydrophobic ionic liquid in a PFPE lubricant may involve dissolving both the PFPE lubricant and the hydrophobic ionic liquid in a solvent. FIG. 4 is a flow diagram of exemplary steps performed to dissolve a hydrophobic ionic liquid in a PFPE lubricant. The operations may begin in step 402 by dissolving a predetermined amount of PFPE lubricant in a solvent. The solvent may be a hydrochlorofluorocarbon (HCFC) based solvent such as, for example, AK225, available from Asahi Glass Co., Ltd. In step 404, a predetermined amount of a hydrophobic ionic liquid, for example, EMIBeti may be dissolved in the solution containing the PFPE lubricant. In step 406, the solvent may be evaporated, thereby leaving behind a solution of PFPE lubricant and the hydrophobic ionic liquid.

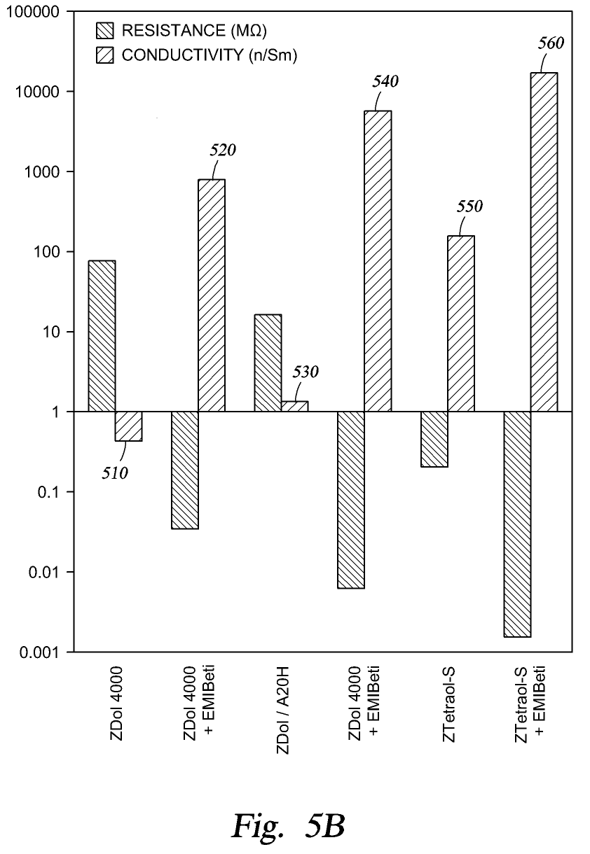

FIG. 5A illustrates the increase in conductivity of PFPE lubricants when 1% by weight of EMIBeti is added. Specifically, FIG. 5 illustrates the increase in conductivity in ZDol-4000, ZDol/A20H, and ZTetraol. For example, row 501 in FIG. 5 illustrates the conductivity of Z-Dol 4000 and row 502 illustrates the conductivity of Z-Dol 4000 containing 1% EMIBeti. Similarly, row 503 in FIG. 5 illustrates the conductivity of Z-Dol/A20H, row 504 illustrates the conductivity of Z-Dol/A20H containing 1% EMIBeti, row 505 illustrates the conductivity of ZTetraol, and row 506 illustrates the conductivity of ZTetraol containing 1% EMIBeti.

Column 580 of FIG. 5A illustrates two exemplary measurements of the change in conductivity of PFPE lubricants, according to an embodiment of the invention. As illustrated in column 580, adding 1% hydrophobic ionic liquid to ZDol and ZDol/A20H increases conductivity of ZDol and ZDol/A20H by around three orders of magnitude. For example, the conductivity of ZDol-4000 increases from 0.45 nS/m to 701 nS/m when 1% EMIBeti is added. Adding 1% hydrophobic ionic liquid to Ztetraol increases conductivity of Ztetraol by around two orders of magnitude. For example, the conductivity of ZTetraol increases from 160 nS/m to 16300 nS/m when 1% EMIBeti is added.

FIG. 5B is a bar graph illustrating the data provided in FIG. 5A. Specifically, FIG. 5B illustrates a bar graph showing the increase in conductivity of PFPE lubricants when 1% EMIBeti is added. For example bars 510 and 520 illustrate the increase in conductivity of ZDol-4000, bars 530 and 540 illustrate the increase in conductivity of ZDol/A20H, and bars 550 and 560 illustrate the increase in conductivity of ZTetraol.

A conductive PFPE lubricant may offer several advantages. As described earlier, a FDB motor generally requires conductive lubricants that operate as a bearing in a sleeve containing the spindle. The conductive PFPE lubricant may be used as the lubricant in the FDB motor in, for example, space 330 of FIG. 3. Therefore, any unwanted charge build up on one or more magnetic disks 110 may dissipate through the spindle 310 and the PFPE lubricant into the spindle motor 300.

Conductive PFPE lubricants may also be used to lubricate the surface of magnetic disks. As discussed above, one common problem with lubricants on the magnetic disk surface is the unwanted buildup of charge on the magnetic disk surface. The unwanted buildup of charge on the magnetic disk surface may occur due to the motion of the head over a magnetic disk surface or a discharge of charged particles from the head to the magnetic disk.

The presence of static charge on the magnetic disk surface may cause the lubricant to degrade and/or accumulate in particular areas of the magnetic disk surface. This may increase the risk of damage to the magnetic disk surface. Furthermore, if the head passes over a region where lubricant has collected, some of the lubricant may accumulate on the head, thereby affecting the movement of the head over the disk surface.

The static charge buildup on the magnetic disk surface may be obviated by using a conductive PFPE lubricant on the magnetic disk surface. Any charge received on a disk surface containing a conductive PFPE disk lubricant may dissipate through the conductive lubricant, to a spindle motor, for example, as previously discussed. Therefore, the accumulation of lubricant in particular areas of the magnetic disk surface and on a head may be obviated.

In one embodiment of the invention, the conductive PFPE lubricant used in a FDB motor may serve as a reservoir of lubricant for a magnetic disk surface. For example, the PFPE lubricant used to formulate the conductive PFPE lubricant may be selected with an appropriate molecular weight distribution and vapor pressure to function as a reservoir. For example, the spinning of the spindle in sleeve 320 may cause some of the PFPE lubricant in the space 330 to vaporize. The vaporized PFPE lubricant may deposit on the surface of the magnetic disk surfaces and replenish the PFPE lubricant that may have been depleted due to movement of the head over the disk surface.

### CONCLUSION

By dissolving hydrophobic ionic liquids in PFPE lubricants, the conductivity of PFPE lubricants may be increased. Conductive PFPE lubricants may therefore be used in components on hardware disk drive components such as FDB motors and magnetic disk surfaces to allow dissipation of unwanted charge buildup on the magnetic disks.

While the foregoing is directed to embodiments of the present invention, other and further embodiments of the invention may be devised without departing from the basic scope thereof, and the scope thereof is determined by the claims that follow.

1. A method for increasing the conductivity of a perfluoropolyether (PFPE) lubricant, comprising:
dissolving a predetermined amount of the PFPE lubricant in a solvent;
dissolving a predetermined amount of a hydrophobic ionic liquid in the solvent; and
evaporating at least some of the solvent, thereby leaving a mixture of the PFPE lubricant and the hydrophobic ionic liquid, wherein the hydrophobic ionic liquid increases the conductivity of the PFPE lubricant.

2. The method of claim 1, wherein the PFPE lubricant is any combination of:
a perfluoropolyoxyalkane based lubricant; and
a Cyclotriphosphazene-Terminated Perfluoropolyether lubricant.

3. The method of claim 1, wherein the solvent is a hydrochlorofluorocarbon based solvent.

4. The method of claim 1, wherein the hydrophobic ionic liquid is 1-Ethyl-3-methylimidazolium bis(pentafluoroethylsulfonyl)-imide.

5. The method of claim 1, wherein the mixture is used as a lubricant in a fluid dynamics bearing (FDB) motor.

6. The method of claim 1, wherein the mixture is used as a lubricant for a magnetic disk surface in a hard disk drive.

7. The method of claim 1, wherein the predetermined amount of hydrophobic ionic liquid is 1% of the mixture.

8. A hard disk drive, comprising:
one or more magnetic disks; and
a FDB motor configured to rotate the one or more magnetic disks, wherein the FDB motor is lubricated with a conductive PFPE lubricant, the conductive PFPE lubricant comprising a mixture of a PFPE lubricant and a hydrophobic ionic liquid.

9. The hard disk drive of claim 8, wherein the PFPE lubricant is any combination of:
a perfluoropolyoxyalkane based lubricant; and
a Cyclotriphosphazene-Terminated Perfluoropolyether lubricant.

10. The hard disk drive of claim 8, wherein the hydrophobic ionic liquid is 1-Ethyl-3-methylimidazolium bis(pentafluoroethylsulfonyl)-imide.

11. The hard disk drive of claim 8, wherein the hydrophobic ionic liquid is 1% of the conductive PFPE lubricant.

12. The hard disk drive of claim 8, wherein the one or more magnetic disk surfaces are lubricated with the conductive PFPE lubricant.

13. The hard disk drive of claim 12, wherein the conductive PFPE lubricant used to lubricate the FDB motor serves as a reservoir to replenish the PFPE lubricant on the one or more magnetic disks.

14. The hard disk drive of claim 8, wherein the conductive PFPE lubricant is configured to discharge an unwanted charge build-up on the one or magnetic disks.

15. A lubricant comprising:
a PFPE lubricant; and
a hydrophobic ionic liquid dissolved in the PFPE lubricant, wherein the hydrophobic ionic liquid is selected to increase the conductivity of the lubricant.

16. The lubricant of claim 15, wherein the PFPE lubricant is any combination of:
a perfluoropolyoxyalkane based lubricant; and
a Cyclotriphosphazene-Terminated Perfluoropolyether lubricant.

17. The lubricant of claim 15, wherein the hydrophobic ionic liquid is 1-Ethyl-3-methylimidazolium bis(pentafluoroethylsulfonyl)-imide.

18. The lubricant of claim 15, wherein 1% of the lubricant is the hydrophobic ionic liquid.

19. The lubricant of claim 15, wherein the lubricant is used to lubricate a fluid dynamics bearing (FDB) motor.

20. The lubricant of claim 15, wherein the lubricant is used to lubricate a magnetic disk surface in a hard disk drive.
